(19) United States
(12) Patent Application Publication
(10) Pub. No.: US 2014/0114817 A1
(43) Pub. Date: Apr. 24, 2014

(54) SYSTEM AND METHOD FOR APPLYING DIVERSE ACCOUNTING EVENTS TO ACCOUNT BALANCES AND GENERATING FINANCIAL REPORTS

(71) Applicant: CLEARWATER ANALYTICS, LLC, Boise, ID (US)

(72) Inventors: Ted Moore, Nampa, ID (US); Rhead Hatch, Kuna, ID (US); Justin Reed, Boise, ID (US); Abraham Alsop, Boise, ID (US); Matthew Lyles, Boise, ID (US)

(73) Assignee: CLEARWATER ANALYTICS, LLC, Boise, ID (US)

(21) Appl. No.: 13/658,603

(22) Filed: Oct. 23, 2012

(51) Int. Cl. G06Q 40/00

(52) U.S. Cl. 705/30

(57) ABSTRACT

A method and system for processing accounting event data and applying the accounting event data to account balances associated with an entity. The system receives accounting event data from multiple third-party financial institutions and uses processing rules to identify activities associated with each accounting event represented in the accounting event data. An activity describes, among other information, a balance to be adjusted and an amount that it is to be adjusted by. A balance quantifies information related to an entity's finances. A balance is adjusted by applying an activity to the balance, thereby increasing or reducing the balance by a specified amount. The system may generate a financial report by applying a template to financial data, including the activities and balances.

### BACKGROUND

Businesses and other entities track their financial accounting events using general ledgers. A general ledger is a collection of accounts to which accounting events, such as transactions, are posted, resulting in debits and credits to the accounts of the ledger. Accounts of a general ledger are typically categorized into assets, liabilities, owner's equity, revenue, and expenses, and sometimes gains and losses as well.

The general ledger reflects all of an entity's financial accounting events. Accordingly, a business may analyze the financial data underlying its general ledger to identify important financial information for its business. For example, both a balance sheet and income statement may be derived from the general ledger. However, while some useful information may be readily ascertainable from a general ledger, much of its potential for use in financial analysis is untapped. Indeed, the financial data and accounting events underlying a general ledger are often too cumbersome and abundant to process and portray in a useful and informative way, particularly for small and medium-sized businesses that lack large teams of financial analysts.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a diagram of a suitable environment in which an accounting event processing system may operate.

FIG. 2 is a block diagram of an accounting event processing system.

FIG. 3 is a flow diagram depicting a method performed by an accounting event processing system to adjust a balance based on accounting event data.

FIG. 4 is a table depicting actions and their various properties that are derived from accounting event data.

FIG. 5 is a flow diagram depicting a method performed by an accounting event processing system to generate a report, such as a general ledger report, using accounting event data.

FIG. 6 is a representative report generated by an accounting event processing system showing a Balance Sheet and Income Statement of a business.

FIGS. 7A-B are representative reports generated by an accounting event processing system showing Income Detail using generally accepted accounting principles (GAAP) and Statutory Accounting Principles (STAT).

FIGS. 8A-D are representative interfaces depicting a wizard through which a representative of an entity may submit information pertaining to a general ledger associated with the entity.

### DETAILED DESCRIPTION

A method and system are described for processing accounting event data and applying the accounting event data to account balances associated with an entity, such as a business, a government entity, a non-profit organization, a family or person with significant financial holdings, or the like. The account balances may be accounts of a general ledger of the entity. The system receives accounting event data from multiple third-party financial institutions and uses processing rules to identify activities associated with each accounting event represented in the accounting event data. Accounting events include transactions (e.g., a purchase or sale of securities, bonds, mutual funds, treasury bills, foreign currency exchanges), periodic calculations (e.g., amortization, accruals, accretion), user updates (e.g., write-downs), and master changes (e.g., security category changes). An activity describes, among other information, a balance to be adjusted and an amount that it is to be adjusted by. A balance quantifies information related to a business's finances. Examples of balances include a cash account balance, an investment portfolio balance (e.g., a quantity of bonds or stocks owned by the business), a credit account, an accounts receivable balance, and the like. A balance is adjusted by applying an activity to the balance, thereby increasing or reducing the balance by a specified amount.

A method and system are also described for generating a report using financial data associated with an entity. A user selects a report that is to be generated and the system identifies user-defined parameters and a template for generating the report. The system also identifies financial data associated with the entity and pertinent to the report, including balances and activities. The system applies the template to the financial data using the user-defined settings to generate the report. In particular, the disclosed system and method enables the generation of a general ledger report associated with an entity.

It will be appreciated that by characterizing each accounting event with one or more activities, the disclosed system and method allows accounting event data from multiple third-party sources to be quickly processed and stored in a detailed fashion. Once stored, the data may be readily manipulated for purposes of generating various reports, such as a general ledger report. By conveniently allowing entities to generate a general ledger report that reflects accounting events associated with multiple source accounts, the disclosed system and method greatly improves the timeliness and accuracy of the financial management and reporting that are available to entities.

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

The following discussion includes examples of a system for tracking financial accounting events and processing, arranging, and portraying information associated with those accounting events. The systems are described with respect to a number of processes that they may implement and numerous examples of how they may be implemented.

### Suitable Environments

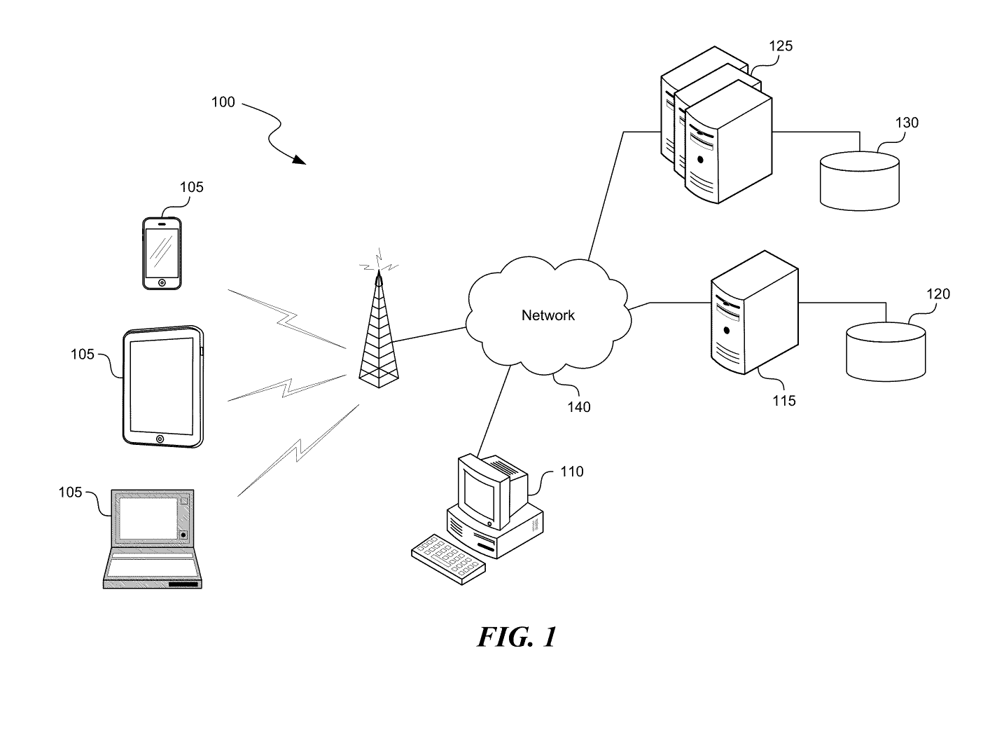

FIG. 1 and the following discussion provide a brief, general description of a suitable computing environment 100 in which an accounting event processing system can be implemented. Although not required, aspects and implementations of the invention will be described in the general context of computer-executable instructions, such as routines executed by a general-purpose computer, a personal computer, a server, or other computing system. The invention can also be embodied in a special purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programmable logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

The system and method can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the invention described herein may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to the example of FIG. 1, an accounting event processing system according to embodiments of the invention operates in or among mobile devices 105, personal computers 110, and one or more server computers 115. The mobile devices 105 and personal computers 115 communicate through one or more wired or wireless networks 140 with the server 115. A data storage area 120 contains data utilized by the accounting event processing system, and, in some implementations, software necessary to perform functions of the system. For example, the data storage area 120 may contain data pertaining to accounting rules and a company's finances and accounting events.

The accounting event processing system communicates with one or more third party servers 125 via public or private networks. The third party servers include servers maintained by entities that periodically send accounting event information to the server 115. The accounting event information may pertain to any financial accounting event associated with an account held by an entity, whether cash, deposits, loans, securities, derivatives, or the like. For example, the accounting event information may include sales or redemptions of financial instruments, purchases of financial instruments, adjustments to financial instruments, exchanges of financial instruments, etc. The accounting event processing system aggregates the date received from the third party servers 125 and stores the received data in data storage areas 125. Data storage areas 125 may also contain data received from mobile devices 105 or personal computers 110.

The mobile devices 105 and computers 110 communicate with each other and the server 115 and third party servers 125 through networks 140, including, for example, the Internet. The mobile devices 105 communicates wirelessly with a base station or access point using a wireless mobile telephone standard, such as the Global System for Mobile Communications (GSM), or another wireless standard, such as IEEE 802.11, and the base station or access point communicates with the server 115 and third party server 125 via the networks 140. Computers 110 communicate through the networks 140 using, for example, TCP/IP protocols.

### Suitable Systems

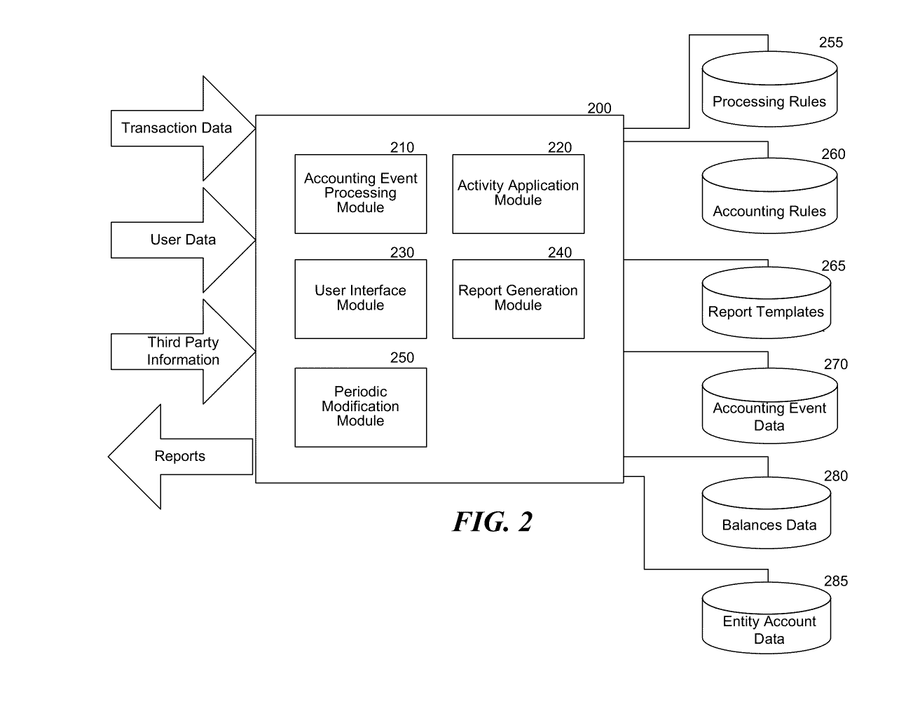

FIG. 2 is a block diagram of an accounting event processing system 200. The accounting event processing system 200 receives and generates accounting event data associated with an entity and deconstructs the accounting event data to identify processing rules that are to be applied to reflect the accounting events, identifies activities to be applied to balances based on the identified processing rules, and adjusts balances associated with the entity based on the identified activities. The accounting event processing system 200 also generates reports pertaining to an entity's finances that are based at least in part on the accounting event data, including a general ledger report.

The accounting event processing system 200 receives accounting event data from one or more third-party providers of accounting event data, and other third party information that is used in the management of the accounting event data. The received accounting event data includes transaction data such as, for example, data related to the buying and selling of securities and other financial instruments. The accounting event processing system may receive transaction data from financial institutions associated with an entity. Third party information includes, for example, master changes, such as security category changes and taxability changes. The third party information is received from third party sources, such as Bloomberg. Third party information also includes information related to assets and securities, such as market prices of securities. The accounting event processing also generates accounting event data based, for example, on security instruments associated with an entity and accounting rules.

The accounting event processing system also receives user data from an entity that utilizes the services of the account event processing system 200. User data from an entity includes, for example, write-downs related to an asset held by the entity as determined by the entity. User data also includes accounting rules or options selected by an entity, configuration settings pertaining to a general ledger that is generated by the system for the entity, and configuration settings and parameters pertaining to reports generated by the accounting event processing system.

The accounting event processing system 200 includes an accounting event processing module 210, an activity application module 220, a user interface module 230, a report generation module 240, and a periodic modification module 250. The accounting event processing system 200 accesses data storage areas, including processing rules data storage area 255, accounting rules data storage area 260, report templates data storage area 265, accounting event data storage area 270, balances data storage area 280, and entity account data storage area 285.

The accounting event processing module 210 analyzes accounting event data to determine the type or types of accounting events represented by the data. Broadly stated, accounting events are events that impact the value or treatment of an entity's holdings that are monitored by the accounting event processing system. Accounting events include transactions, periodic calculations, user updates, and master changes. Transactions are received from financial institutions, and they include such events as a purchase or sale of an asset. Periodic calculations are generated by the periodic modification module 250 and are based on terms and conditions of a security instrument and accounting rules. Examples include amortization, accruals, and accretion. User updates are entity-initiated changes to a particular holding. An example of a user update is a write-down to an asset held by the entity to reflect a reduction in book value. Master changes are received from third parties, such as from Bloomberg. Examples include security category changes and taxability changes that typically impact multiple entities across a particular industry. The accounting event processing module 210 may identify the type of accounting event by identifying keywords or codes included in the accounting event data. Indeed, providers of accounting event data will often facilitate the identification of particular accounting events by the inclusion of unique codes in the data that they provide which is decoded by the accounting event processing module. For example, the accounting event data may specify a type of accounting event, such as a “Buy” accounting event or a “Sell” accounting event. The types of accounting events that are processed by the system may be specified by a system user, and may be added, deleted, or modified over time.

Based on the type of accounting event, the accounting event processing module 210 identifies processing rules to apply to the accounting event data. The accounting event processing module 210 accesses processing rules from data storage area 255. The processing rules identified by the accounting event processing module include instructions for parsing the accounting event data and identifying activities, activity parameters, and values for the activity parameters. For example, if an accounting event is identified as a “Buy” accounting event, the accounting event processing module 210 identifies the processing rule to apply to Buy accounting events. As will be described in additional detail herein, the processing rule will specify one or more activities that are to be applied by the system to certain balances in order to record the accounting event. The accounting event processing module also stores activities and accounting event data in data storage area 270. The accounting event processing module 210 obtains accounting rules associated with an entity from accounting rules data storage area 260. In some implementations, the accounting event processing module 210 selects a processing rule including an activity, a parameter of the activity, or a value of a parameter of the activity based at least in part on accounting rules.

The activity application module 220 applies activities that are associated with a processing rule to a balance associated with each activity. As discussed below, parameters of an activity include a balance that the activity is to be applied to, an amount that is to be applied, and whether the balance is to be increased or decreased by the specified amount. When the activity application module 220 applies the activity to a balance, it increases or decreases the balance by the amount. The activity application module accesses balances associated with an entity in data storage area 280. The balances may include accounts included in a general ledger, including, for example, a cash account, an accounts receivable account, and so forth. The activity application module 220 also identifies errors in applying activities to balances. For example, the activity application module may perform a reconciliation process to ensure that debit and credit amounts associated with an entity are the same.

The user interface module 230 generates a graphical user interface from which a user may submit settings, modify activity rules or accounting rules, select a report to generate, view a report, and so forth.

The report generation module 240 generates financial reports based on financial data, including balances and activities. The report generation module 240 obtains balances and associated data from balance data storage area 280 and activities and associated data from accounting event data storage area 270. The report generation module 240 generates a report using a template obtained from the report template data storage area 265. The template includes rules related to the balances and activities that are reflected in the report, as well as formatting instructions. For example, one of the types of reports that may be generated by the report generation module is a general ledger report.

The periodic modification module 250 generates periodic accounting events based, at least in part, on assets held by an entity. Periodic accounting events are those events that are periodically and automatically executed which impact the value of an asset. Examples of periodic accounting events include, but are not limited to, amortization, accruals, and accretion. Periodic accounting events may be generated based on, for example, accounting rules or terms and conditions of a security instrument. The periodic modification module 250 accesses information pertaining to assets held by an entity in entity account data storage area 285.

### Example Processes

### 1. Processing of Accounting Event Data

The accounting event processing system 200 processes accounting event data related to an entity, identifies processing rules associated with accounting events contained in the data, identifies activities associated with the processing rules, identifies parameters associated with the activities, and applies those activities to balances associated with the activities. It also generates reports using financial data pertaining to the entity, including activities derived from the accounting event data.

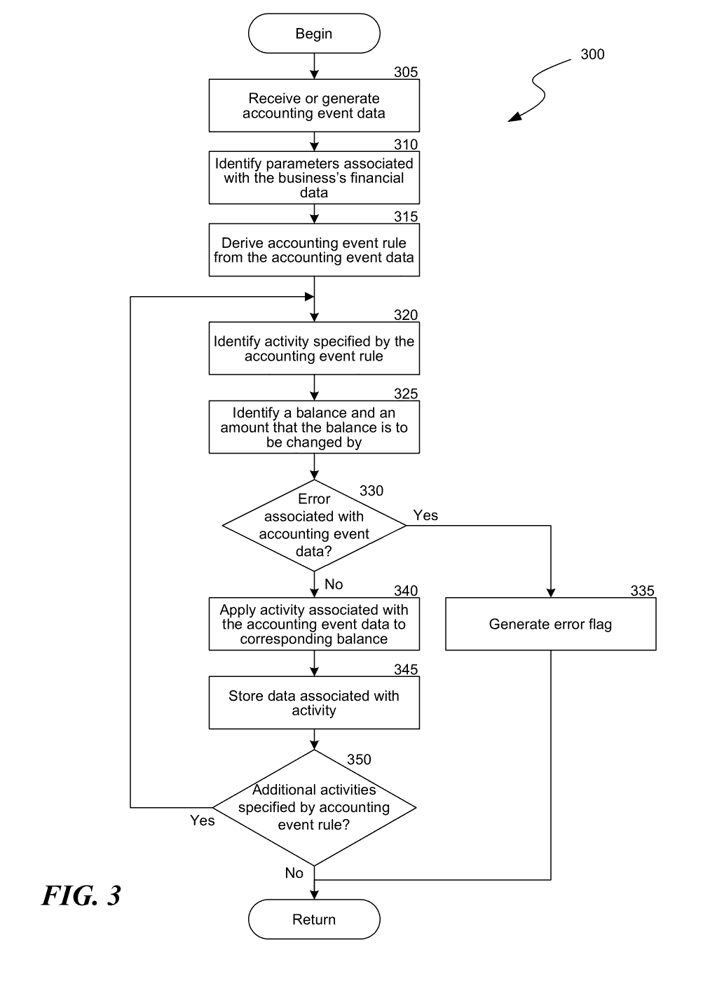

FIG. 3 is a flow diagram representing a process 300 performed by the accounting event processing system 200 for adjusting a balance based on received or generated accounting event data. A balance quantifies information related to an entity's finances. Examples of balances include a cash account balance, an investment portfolio balance (e.g., a quantity of bonds or stocks owned by the entity), a credit account balance, an accounts receivable balance, and the like, that are owned or controlled by the entity. A balance is adjusted by applying an activity to the balance. At a block 305, the accounting event processing system 200 receives or generates accounting event data. In some implementations, accounting event data is received from one or more third-party financial institutions that hold or manage accounts on behalf of the entity. The financial institutions may include, but are not limited to, banks, credit unions, trust companies, loan companies, insurance companies, brokers, underwriters, investment advisors, investment funds, or the like. The received or generated accounting event data is associated with the financial accounts of an entity, and includes journal entries or other data that pertains to one or more financial accounting events.

The financial institutions may automatically or manually transmit accounting event data to the accounting event processing system 200. For example, financial institutions having a relationship with an entity may operate systems that automatically transfer accounting event data to the accounting event processing system. Accounting event data is typically received from financial institutions on a regular basis associated with underlying account reconciliation processes, such as on a monthly, quarterly, and/or yearly basis. Systems associated with a third party executing accounting events on behalf of the entity may also automatically send accounting event data to the accounting event processing system 200 when the entity completes an accounting event. For example, a brokerage firm may automatically send accounting event data to the accounting event processing system 200 when an entity buys a security. As an alternative to automatically receiving data from financial institutions, a user of a desktop computer may access a user interface generated by the accounting event processing system and access accounts at financial institutions to download files containing accounting event data associated with the entity to the system or to otherwise manually enter accounting event data.

Accounting event data may also be generated by the accounting event processing system 200 or received from sources that do not hold or manage accounts on behalf of the entity. In some implementations, accounting event data is received from a user associated with an entity. For example, a user associated with an entity may submit accounting event data pertaining to a write-down. In some implementations, accounting event data is received from a third party and includes master changes, such as changes to a security category and changes to a taxability of a security. In some implementations, accounting event data is generated based on periodic calculations, such as amortization, accruals, and accretion. For example, the accounting event processing system may periodically calculate amortization, accruals, and accretion based at least in part on terms and conditions of a security instrument held by an entity and accounting rules.

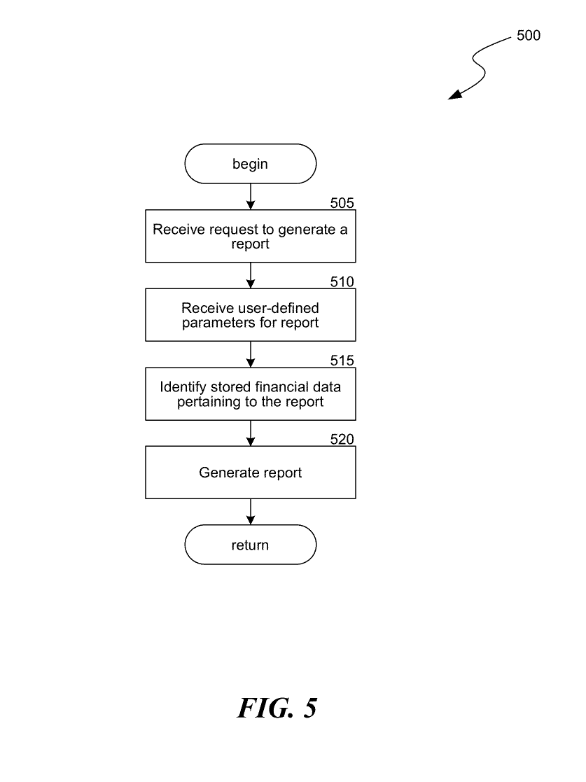

At a block 310, the accounting event processing system identifies parameters associated with the entity's financial data. For example, as discussed more extensively below with respect to FIG. 5, the accounting event processing system accesses settings associated with an entity's use of the accounting event processing system, including user-defined settings or settings that are used or available to be used because of the nature of type of the entity or a status of the entity. For example, an entity may specify which accounting method (e.g. cost accounting, fair value accounting, etc.) the accounting event processing system should use in managing and applying accounting event data with regard to the entity's finances. Or an entity may be a certain type of entity, such as an insurance company, and may therefore have different parameters associated with its financial data than a generic small business.

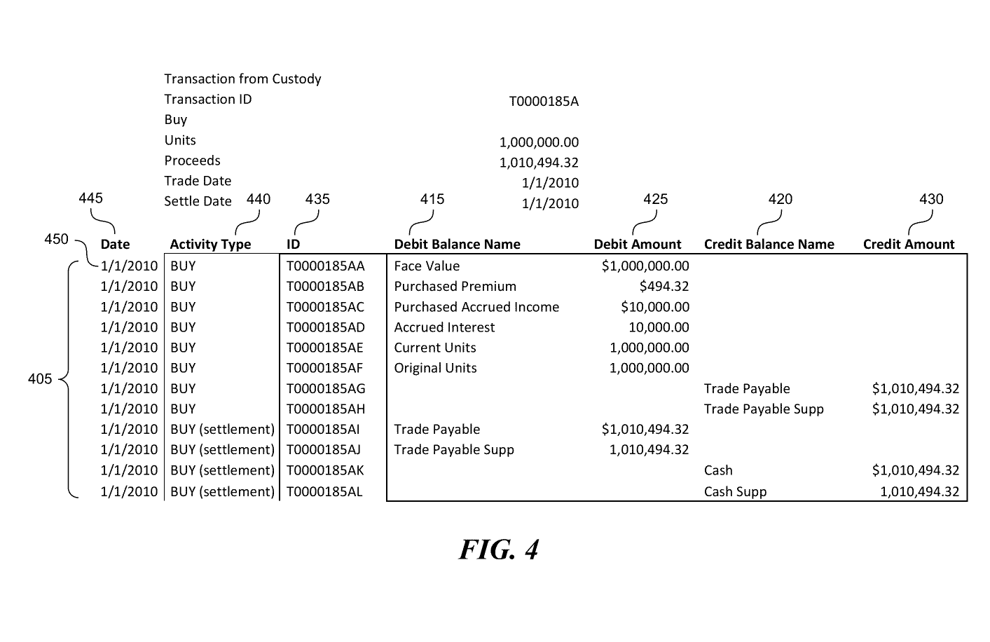

At a block 315, the accounting event processing system identifies a processing rule associated with an accounting event contained in the accounting event data. Each processing rule specified one or more activities that are associated with that accounting event. An activity includes information for adjusting a balance. It describes, among other information, a balance to be adjusted and an amount that it is to be adjusted by. For example, FIG. 4 is a table showing activities 405 associated with an accounting event to buy units of a security. The activities 405 are specified by the processing rule that is applied to security accounting events. The activities 405 are each associated with a balance, represented by either a debit balance name 415 or a credit balance name 420. The activities are also associated with an amount that the balance is to be changed by, represented by either a debit amount 425 or a credit amount 430. Activities can also include other information, including a description of a type of the activity and an identifier of the activity. The table of FIG. 4 includes an ID column 435, which specifies a unique identification number for each activity, and an activity type column 440, which specifies a type of activity (e.g., a “Buy” activity). Activity types include, but are not limited to, Buy, Sell, Dividend, Coupon Transfer Paydown, Maturity, Redemption, Management Fee, Amortization Expense, Stock Split, Write-Down, and the like. Activities may also be associated with a date, such as a date of an accounting event or a date that the action is to be or was executed on. The table of FIG. 4 includes a date column 445, which specifies the date on which a corresponding action is executed. In some implementations, accounting event data associated with one security type will have different activities associated with it than accounting event data associated with another security type.

The accounting event processing system analyzes the accounting event data to identify accounting events in the data. Each accounting event in the accounting event data may be represented by a code, keyword, or other identifier. Typically, companies providing the accounting event data will prove decoding information to allow the accounting event processing system to interpret the received data. Alternatively, the operator of the accounting event processing system may review the accounting event data and characterize certain accounting events for subsequent processing by the system.

Once the accounting event processing system has identified one or more accounting events in the accounting event data, the system applies the appropriate processing rules and activities specified by the processing rules. A processing rule may be a default rule supplied by the system or it may be supplied by the entity that uploads the accounting event data to the accounting event processing system. A processing rule identifies activities and corresponding parameters associated with a type of accounting event. It provides information necessary for the accounting event processing system to identify not only the activities and parameters that are associated with received accounting event data, but also the values that should be associated with the parameters. In some implementations, the accounting event processing system considers the parameters identified at block 310 in selecting the appropriate processing rule with respect to the accounting event data. Similarly, a processing rule may be amended due to the parameters identified at block 310. For example, the accounting event processing system may use a processing rule associated with GAAP accounting instead of a processing rule associated with STAT accounting if a parameter associated with the entity specifies that the entity uses GAAP accounting.

The processing rule that is used by the accounting event processing system identifies those activities that are associated with an accounting event. For example, the accounting event associated with the activities 405 of the table of FIG. 4 is a “Buy” accounting event. The accounting event data associated with a Buy accounting event includes a number of units that are bought, the proceeds for the accounting event, and a trade and settle date for the accounting event. The accounting event processing system utilizes the processing rule associated with Buy accounting events to identify the activities 405 and parameters associated with the activities, including the activity type 440, debit balance name 415, and so forth. At a block 320, the system selects one activity for processing from the processing rule.

At a block 325, the accounting event processing system identifies a balance that is associated with the selected activity. The accounting event processing system may identify the balance in the accounting event data. Alternatively, it may identify the balance using a rule associated with the activity. For example, a rule may instruct the accounting event processing system to use a cash account balance for a particular activity. Referring again to FIG. 4, a first activity 450 is associated with a balance called “Face Value.” A balance may be a composite balance, which represents a combination of balances.

At block 325, the accounting event processing system also identifies an amount that the balance is to be changed by. The identified amount is derived from the accounting event data and determined using the rules associated with the activity. In some implementations, the amount is a default amount that is used for a particular activity. For example, an activity may be associated with a flat tax applied to a particular type of accounting event. Referring again to FIG. 4, the first activity 450 is associated with the amount $1,000,000.00, which the system determined using an access rule and the accounting event data.

The amount associated with an activity may be a monetary amount or a unit amount consistent with the balance that it is to be applied to. The amount may also cause the balance to be increased or decreased. Depending on the type of balance, an amount adding to the balance may be presented as a debit or a credit. For example, the amount for the first activity 450, the “Face Value” balance amount is an increase and therefore presented as a “Debit Amount.” In contrast, the “Trade Payable” amount is a different type of balance, and the amount is also an increase, but is presented as a “Credit Amount.”

At a decision block 330, the accounting event processing system determines whether execution of the activity would cause an error or is otherwise associated with an error. An error may occur when information associated with the activity is inconsistent, when the name of a balance associated with an activity is not recognized, or when the accounting event processing system is otherwise unable to properly apply an activity. For example, the system may identify an error when the balance name associated with an activity is not recognized. In some implementations, the accounting event processing system performs a reconciliation process with respect to balances affected by activities. For example, the accounting event processing system may compare the amount of money credited to balances as a result of activities associated with received accounting event data and the amount of money debited from balances as a result of activities associated with accounting event data to identify whether an error occurred in applying the activities or if the accounting event data was faulty.

If the accounting event processing system detects an error, the process 300 proceeds to a block 335 and the accounting event processing system generates an error flag and the process 300 returns. In some implementations, the system stores the activity and/or accounting event data for later analysis or processing. In some implementations, the system applies rules to reconcile an error.

If the accounting event processing system does not detect an error, the process 300 proceeds to a block 340, and the accounting event processing system applies the activity to the balance identified by the activity, either adding to or subtracting from the balance. For example, referring to the first activity 450 of FIG. 4, the accounting event processing system debits the balance named “Face Value” by $1,000,000.00. At a block 345, the accounting event processing system stores data associated with the activity. Activity data is stored in association with related activity data. For example, activities from a same accounting event may be stored having related identifiers. By storing the activity data, the accounting event processing system is able to maintain an audit trail that allows any accounting event to be reversed should errors or other circumstances warrant backing-out the accounting event data.

At a decision block 350, the accounting event processing system determines whether any other activities are associated with the selected processing rule. If additional activities need to be executed by the system, processing returns to a block 320 where an additional activity is selected by the system for processing. The system processes the selected activity in accordance with blocks 325-350. If no additional activities are specified by the processing rule at block 350, processing returns. In this fashion, each activity specified by a processing rule is processed by the system.

In some implementations, the accounting event processing system 200 applies a processing rule and all activities upon receipt of the underlying accounting event data. However, in other implementations, the accounting event processing system stores the accounting event data and periodically executes all processing rules received during a particular time period. Accordingly, the accounting event processing system may apply a processing rule at a particular time every day or at a particular frequency. The accounting event processing system may also wait to apply processing rules until a user requests a report.

One of the advantages in breaking down each accounting event into its constituent activities is that the accounting event processing system 200 is able to reconcile data received in different formats and with a varying level of detail from different sources. Because accounting event data may be received from many sources of various sophistication and capabilities, the received accounting event data may vary significantly in level of detail that is provided. Applying different activities to each accounting event allows the underlying accounting event to be deconstructed and stored in a common data set reflecting all accounting events. As will be described in additional detail herein, doing so improves the reconciliation and reporting that may be performed by the system.

### 2. Generating Reports

FIG. 5 is a flow diagram representing a process 500 performed by the accounting event processing system 200 for generating a report related to an entity's finances. The accounting event processing system 200 generates the report using stored financial data related to the entity and processed activities derived from accounting event data. At a block 505, the report generation module 240 receives a request from a user to generate a report. The user may have previously registered an account associated for the entity with the accounting event processing system, and an administrator of the accounting event processing system or an account associated with the entity may have authorized the user to access the entity's financial data. The user may request that a report be generated using a graphical user interface generated by the report generation module and displayed on a computer or mobile device associated with the user. The user interface displays options for the user to select in order to identify the report that the user wishes to have generated.

The accounting event processing system may generate any of a number of different reports using the stored financial data and activities derived from accounting event data. For example, the accounting event processing system 200 may generate accounting reports, compliance reports, performance reports, and risk reports. Examples of accounting reports include reports related to balance sheet by position, balance sheet by lot, trading activity, accounting event detail, income detail, interest income, amortization/accretion, realized gain/loss, roll-forward, impairment, impairment, and STAT or GAAP specific reports, including an FAS 157 disclosure, SSAP 100 disclosure, and SSAP 100 Level 3 Roll. Compliance reports identify whether an entity is complying with its stated investment policies. A compliance report may also identify violations of an entity's investment policy. Performance reports identify an entity's investment returns, its contributions to particular accounts, comparisons to other investments, and so forth. Risk reports identify a portfolio's exposure or risk. Risk reports may display a portfolio's allocation of assets to particular countries, particular credit ratings, equity sectors, market capitalizations, currencies, business sectors, security types, and so forth.

While the accounting event processing system is able to generate a large number of reports, in particular it is able to generate a general ledger (GL) report for an entity. As will be described in additional detail herein, the GL report may be accurately generated because each accounting event has been broken down by the system to its constituent activities. When the activities are applied across the company's balances, the system therefore allows the balances to be more readily rolled-up for reporting purposes.

At a block 510, the accounting event processing system receives user-defined parameters for generating the report. User-defined parameters include how accounting rules will be applied (e.g., whether GAAP or STAT accounting is to be used), geographic or jurisdictional information (e.g., the identification of a jurisdiction for tax purposes), and a choice of data elements that the accounting event processing system is to use in creating the report (e.g., all accounting events from a particular year). User-defined parameters may also include parameters pertaining to a market value breakdown, an accrued interest grouping, income balances, security groupings, and an FAS 115 method. A user may submit the user-defined parameters through a graphical user interface generated by the accounting event processing system and displayed by a computer or mobile device. For example, a user associated with the entity may register an account for the entity with the accounting event processing system. During a registration process, the accounting event processing system 200 may generate a wizard that prompts the user to enter account information or submit or select parameters that are to be used for grouping and combining activities and for generating reports.

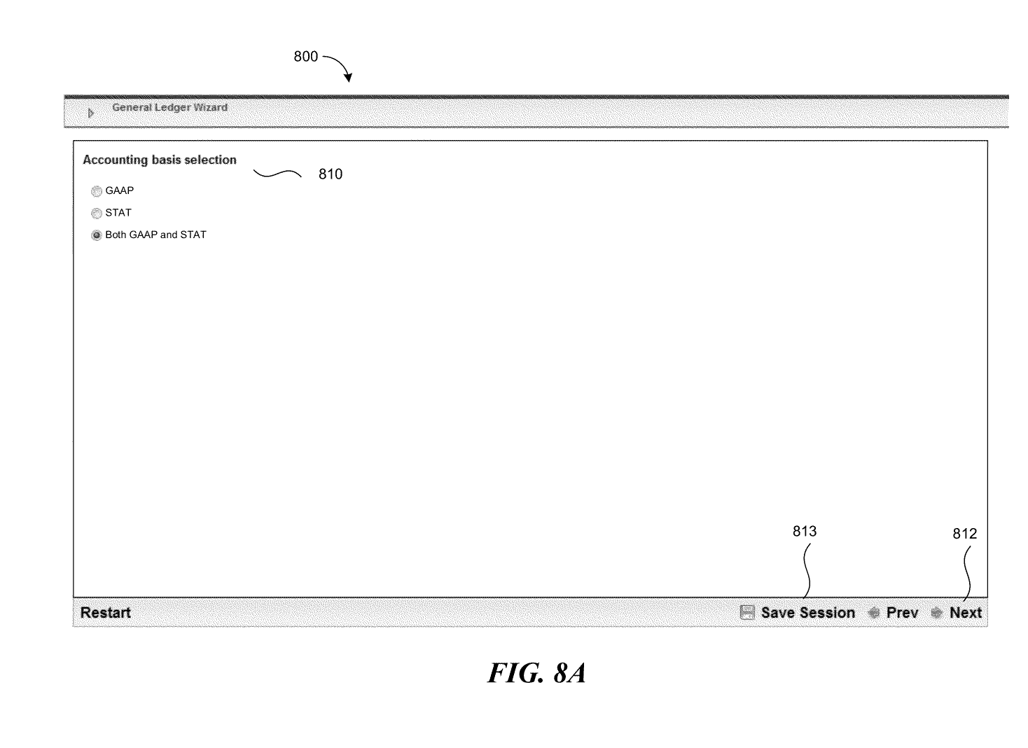

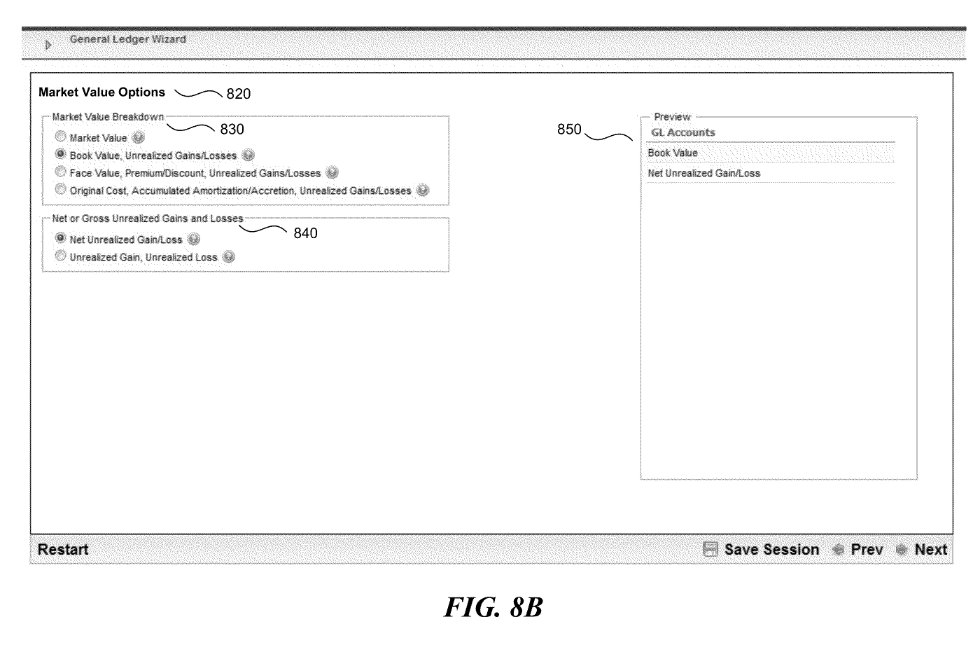

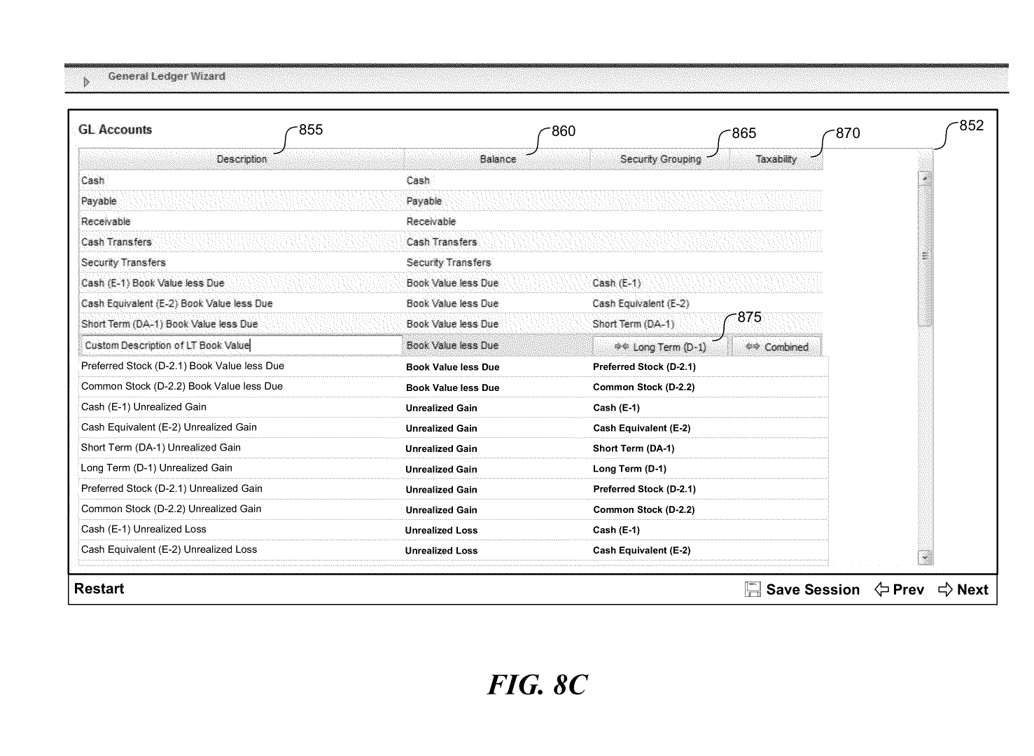

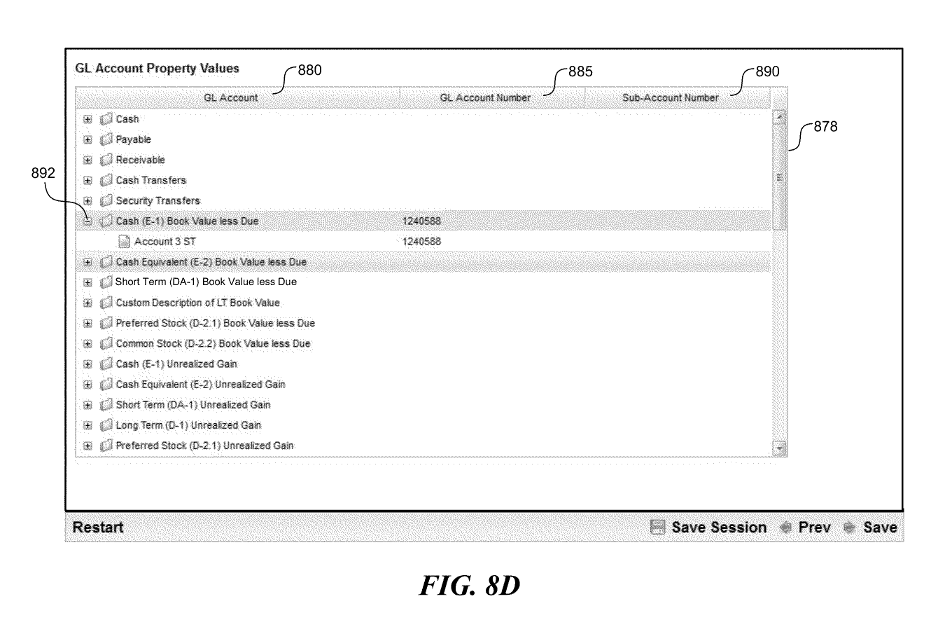

FIGS. 8A-D are representative interfaces of a wizard generated by the system 200 that allow a user associated with an entity to submit account information and parameters associated with the entity. FIG. 8A shows an interface 800 through which the user may select an accounting option 810. The user may select a radio button associated with accounting options GAAP, STAT, or both GAAP and STAT, and the user may select a “save session” button 813 to save the user's session or a next button 812 to proceed to another page. FIG. 8B shows an interface through which the user may select market value options 820. The market value options 820 include a market value breakdown option 830 and a net or gross unrealized gains and losses option 840. The interface also includes a preview area 850 that displays a preview of general ledger accounts and parameters selected by the user. As the user selects the various options presented in the wizard, the preview area 850 depicts the impact of the selected options on the GL. In this fashion, the user is able to immediately see the impact of each option and can change selected options if the GL that is being generated does not reflect a desired GL. FIG. 8C shows an interface through which the user may view and edit general ledger accounts that are associated with the entity. The interface includes a table 852 that includes a description column 855, a balance column 860, a security grouping column 865, and a taxability column 870. The user may modify information associated with each of the displayed accounts. For example, a user may select a row pertaining to an account and edit the information in the row. The user may select, for example, the Custom Description of LT Book Value row and select a long term button 875 in the security grouping column 865 to specify that the Custom Description of LT Book Value account is associated with a long term (D−1) security grouping. Similarly, the user may select a button in the taxability column 870 to specify the tax treatment that should be applied to the account. FIG. 8D shows an interface through which a user may view and modify GL account property values. The interface includes a table 878 that includes a general ledger (GL) account column 880, a GL account number column 885, and a sub-account number column 890. The user may select a row of the table to select a particular GL account. To view more information associated with the selected GL account, the user operates a control 892 associated with the row. When the control is operated, the system generates a list of all of the individual accounts that are associated with the selected GL account. The table 878 thereby allows the user to confirm appropriate treatment of each account within the GL.

A user may also submit user-defined parameters through a graphical user interface generated by the accounting event processing system 200 after having registered with the system. In some implementations, settings available to be defined by a user depend on a status of the user or entity. For example, a user associated with a sophisticated corporation, like an insurance company, may be allowed to define more or different settings than a user associated with a less sophisticated corporation, like a small business. In some implementations, a user defines settings in advance of requesting that the accounting event processing system prepare a report. For example, a user may submit preferred settings, such as that the accounting event processing system use GAAP accounting, when the user registers with the accounting event processing system. In some implementations, the accounting event processing system uses default settings for the user-defined parameters until the user changes the settings.

At a block 515, the accounting event processing system identifies stored financial data that pertains to the report that the user has requested be generated. Financial data includes balances, previous accounting events, activities that have been applied to pertinent balances, and so forth. For example, to generate a risk report related to a portfolio's exposure to currencies, the accounting event processing system may identify cash balances and securities owned by the entity including information related to the currencies of the cash and currencies that the securities trade in.

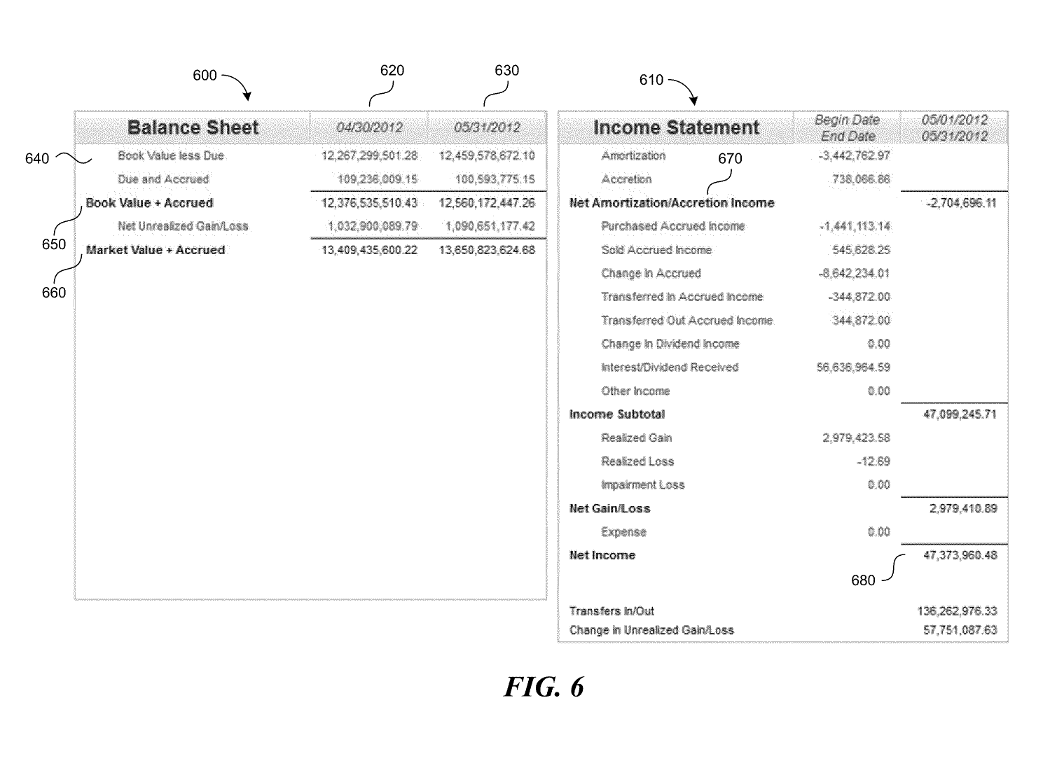

At a decision block 520, the accounting event processing system generates the report using the user-defined parameters and the stored financial data. The accounting event processing system builds the report using a template stored in association with the system. The template that the system uses is associated with the report identified by the user at block 505. FIG. 6 is a representative report that the accounting event processing system generates, showing a balance sheet 600 and an income statement 610 associated with an entity. The balance sheet 600 includes various categories of data representing the entity's finances, including, for example, a book value 640 of the entity's investment portfolio, a book value plus accrued balances 650, and either market value plus accrued, or unrealized gains or losses. The income statement 610 also includes various categories of data representing the entity's income, including, for example, net amortization and accretion income 670 and net income 680.

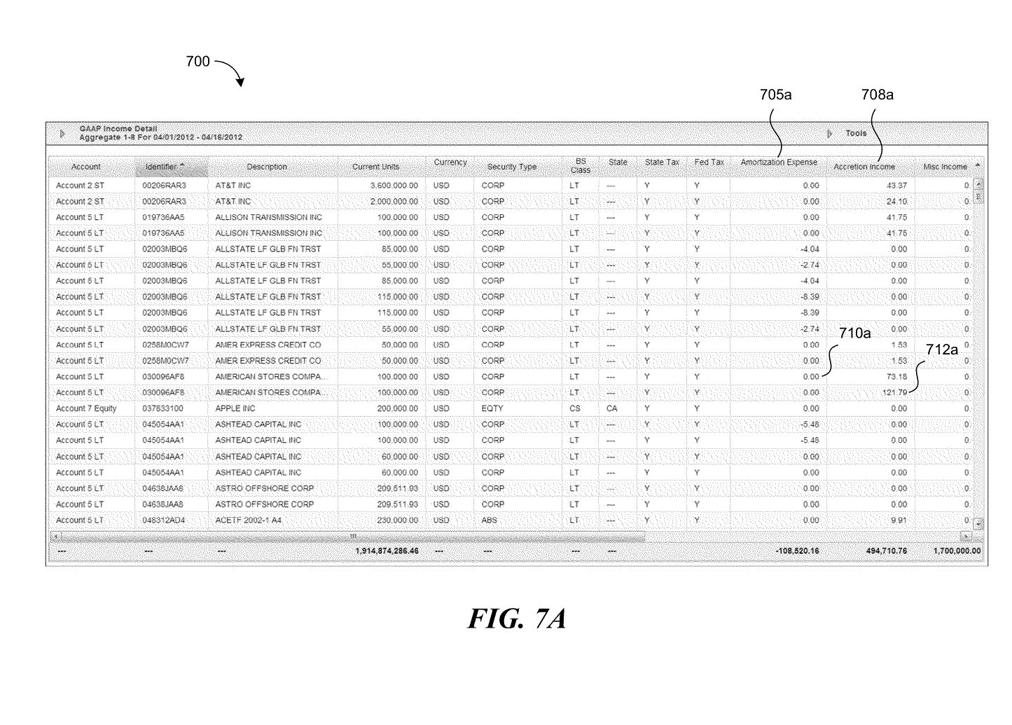

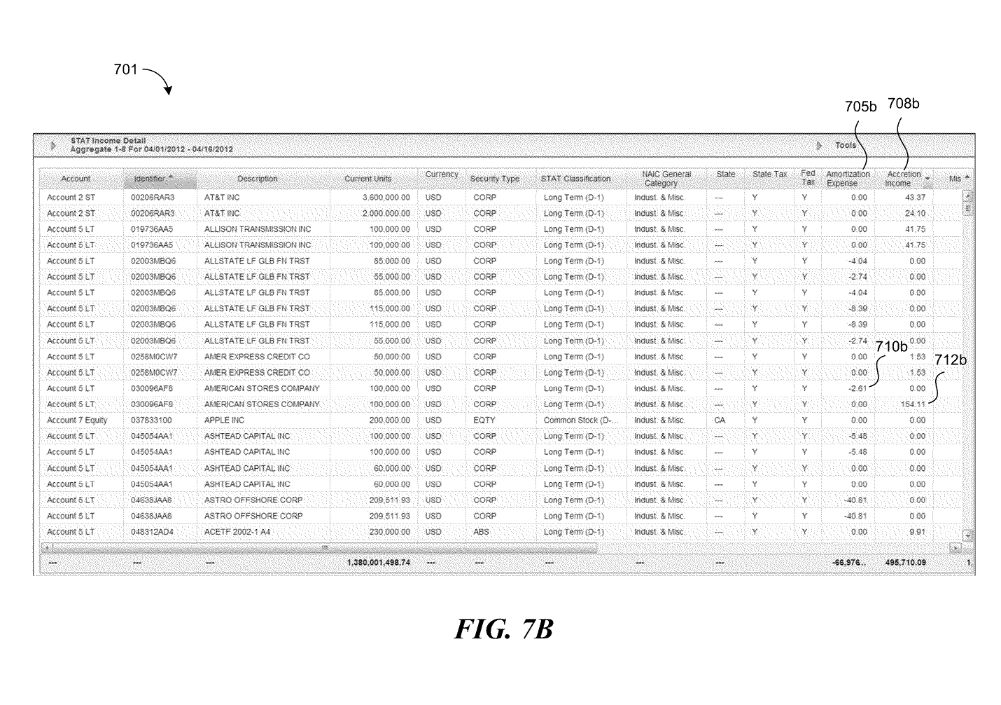

FIGS. 7A and 7B are also representative reports that the accounting event processing system generates. FIG. 7A represents an income detail report 700 generated using GAAP accounting and FIG. 7B represents an income detail report 701 generated using STAT accounting. Although the income reports are generated using the same financial data, the reports are different as a result of the accounting method used. For example, each income report 700, 701 includes a column for amortization expense 705a, b and a column for accretion income 708a, b. Although both reports were generated using the same data, an amortization expense 710a for identifier 030096AF8 is 0.00 for the GAAP income detail report 700 and an amortization expense 710b for identifier 030096AF8 is −2.61 for the STAT income detail report 701. Similarly, accretion income for identifier 030096AF8 is 121.79 in the GAAP income detail report 700 and 154.11 in the STAT income detail report. As discussed above, the different accounting methods may affect how activities are applied to balances or which activities are applied based on received accounting event data.

### Additional Modules

The disclosed system characterizes accounting events granularly with one or more activities. Once stored, the data can be used among different modules to convey an array of useful information for an entity. In addition to accounting, among the modules that use this common data are compliance, risk, and performance modules.

A compliance module uses stored activities to provide an entity with an automated investment policy monitoring solution with real-time compliance information. The compliance module incorporates accounting-based compliance rules to view different security exposures, and it may do so at regular intervals, even on a daily basis. The compliance module can generate various reports, including those directed to status, violations, history, and audit. Through these reports, an entity owns its investment policies with immediate answers to compliance issues. Entities are able to filter reports based on a type of policy, a rule, and dates of violations. As a result, entities have clarity into investment compliance, confidence in the numbers, and control over compliance issues.

A risk module uses stored activities to provide an entity with a holistic view of investment portfolio risk factors. The risk module provides information to an entity regarding risk-related issues, including exposures by issuer, currency, country, duration, credit rating, and so on. And since stored activities are updated regularly, including, for example, on a daily basis, risk data may be aggregated, reconciled, and validated frequently, providing an entity a comprehensive and up-to-date view of investment portfolio risk.

A performance module uses stored activities to provide entities with reporting and analytical tools to compare the performance of accounts relative to each other and to custom benchmarks. The performance module uses consistent assumptions in accordance with the Global Investment Performance Standard (GIPS) to provide an entity an accurate, flexible, and meaningful view of performance. By using stored activities to analyze a performance associated with an entity's investments, the performance module can provide performance analysis over a customizable date range, viewable at an individual, composite, or aggregate level.

The discussed modules can deliver consolidated and up-to-date investment portfolio reporting and analytics for entities. Regardless of the different sources from which it receives its data, the disclosed system can aggregate, independently verify, and confirm investment portfolio information. The modules deliver transparent, integrated, and actionable multi-basis and multi-currency accounting, compliance, risk and performance reporting, and analytics built on a foundation of reconciled, tax-lot level data. The modules provide entities with views at individual portfolio, composite, and aggregate levels, allowing drill-down functionality to individual securities.

### CONCLUSION

Those skilled in the art will appreciate that the actual implementation of a data storage area may take a variety of forms, and the phrase “data storage area” is used herein in the generic sense to refer to any area that allows data to be stored in a structured and accessible fashion using such applications or constructs as databases, tables, linked lists, arrays, and so on.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times.

In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

I/We claim:

1. A method for generating a financial report using accounting event data pertaining to an accounting event executed by an entity, the method performed by a computing system having a processor and a memory, the method comprising:
receiving accounting event data associated with a financial accounting event executed by an entity;
identifying a processing rule associated with the accounting event data, wherein the processing rule is selected based at least in part on the accounting event data, the processing rule specifying one or more activities related to financial balances associated with the entity;
for each activity in the identified processing rule:
identifying a balance that the activity is to be applied to;
identifying an amount that the balance is to be changed when the activity is applied to the balance; and
applying the activity to the identified balance, wherein the balance is either increased or reduced by the identified amount; and
receiving parameters pertaining to an application of accounting events for generating a general ledger report;
receiving a request to generate a general ledger report associated with the business;
selecting a template corresponding to the financial report requested to be generated; and
generating the report by applying the template to financial data associated with the entity according to the parameters pertaining to the application of accounting events for generating the general ledger report, wherein the financial data includes the financial balances that accounting event activity is applied against.

2. The method of claim 1, wherein the one or more activities are usable without modification among an accounting module, a compliance module, a risk module, and a performance module.

3. The method of claim 1, further comprising receiving an indication of an accounting method used by the entity, wherein at least one of the processing rules and the balance of an activity are identified based at least in part on the accounting method used by the entity.

4. The method of claim 1, wherein the accounting event data is received from multiple third-party financial institutions that track financial instruments on behalf of the entity.

5. The method of claim 1, wherein the amount associated with an activity is specified in the accounting event data.

6. The method of claim 1, wherein the amount associated with an activity is a default amount based at least in part on the activity.

7. The method of claim 1, wherein the template is selected based at least in part on an accounting method used by the entity.

8. The method of claim 1, wherein the balance is associated with an account of a general ledger.

9. The method of claim 1, wherein the accounting event data includes data pertaining to at least one of an amortization, an accretion, or an accrual.

10. A method of processing accounting event data pertaining to financial accounting events executed by an entity, the method performed by a computing system having a processor and a memory, the method comprising:
identifying accounting event data associated with financial accounting events executed by an entity, wherein the accounting event data includes accounting event data received from multiple third parties that track financial instruments on behalf of the entity;
identifying a processing rule associated with each financial accounting event represented by the accounting event data, wherein each processing rule is selected based at least in part on the identified accounting event data, each processing rule specifying one or more activities related to financial balances associated with the entity;
for each activity in an identified processing rule:
identifying a balance that the activity is to be applied to;
identifying an amount that the balance is to be changed when the activity is applied to the balance; and
applying the activity to the identified balance, wherein the balance is either debited or credited by the identified amount; and
storing a record of all activities applied against the financial balances associated with the entity.

11. The method of claim 10, wherein the record of all activities applied against the financial balance associated with the entity is usable without modification as data common to an accounting module, a compliance module, a risk module, and a performance module.

12. The method of claim 10, further comprising receiving an indication of an accounting method used by the entity, wherein a processing rule or a balance of an activity is identified based at least in part on the accounting method used by the entity.

13. The method of claim 10, wherein the amount associated with an activity is specified in the accounting event data.

14. The method of claim 10, wherein the amount associated with an activity is a default amount based at least in part on the activity.

15. The method of claim 10, wherein the balance is associated with an account of a general ledger.

16. A system for generating a general ledger report using accounting event data pertaining to accounting events executed by an entity, the system comprising:
a memory storing computer-executable instructions of:
an accounting event processing module configured to receive accounting event data associated with financial accounting events executed by an entity, identify processing rules associated with the accounting event data, wherein each processing rule is selected based at least in part on the accounting event data and specifies one or more activities related to financial balances associated with the entity, and, for each activity in the identified processing rule:
identify a balance that the activity is to be applied to;
identify an amount that the balance is to be changed when the activity is applied to the balance; and
apply the activity to the identified balance, wherein the balance is either debited or credited by the identified amount; and
a report generation module configured to receive a request to generate a general ledger report for the entity and generate the general ledger report using financial data associated with the entity and parameters pertaining to an application of accounting events for generating the general ledger report, wherein the financial data includes the financial balances that accounting event activity is applied against; and
a processor for executing the computer-executable instructions stored in the memory.

17. The system of claim 16, wherein each activity is usable without modification among an accounting module, a compliance module, a risk module, and a performance module.

18. The system of claim 16, wherein the accounting event processing module is further configured to receive an indication of an accounting method used by the entity, and at least a processing rule or a balance of an activity is identified based at least in part on the accounting method used by the entity.

19. The system of claim 16, wherein the accounting event data is received from multiple third-party financial institutions that track financial instruments on behalf of the entity.

20. The system of claim 16, wherein the amount associated with an activity is specified in the accounting event data.

21. The system of claim 16, wherein the amount associated with an activity is a default amount based at least in part on the activity.
